(19) United States
(12) Patent Application Publication
(10) Pub. No.: US 2013/0147582 A1
(43) Pub. Date: Jun. 13, 2013

(54) Propulsion means using magnetic field trapping superconductors

(71) Applicant: Nassikas A. Athanassios, Larissa (GR)

(72) Inventor: Nassikas A. Athanassios, Larissa (GR)

(21) Appl. No.: 13/815,180

(22) Filed: Feb. 6, 2013

Related U.S. Application Data
(63) Continuation-in-part of application No. 13/373,403, filed on Nov. 14, 2011.

(51) Int. Cl. H01F 6/00

(52) U.S. Cl. CPC H01F 6/00
USPC 335/216

(57) ABSTRACT

A means for the creation of propulsive force and an apparatus for implementing the means comprising a solenoid, such as a superconductive electromagnet, located at the narrow end of a tapered tube whose solid parts are made of a superconductor with high magnetic field trapping ability, such as the type II superconductor Y—Ba—Cu—O, and within which a propulsive force is developed. The magnetic field generated by the solenoid repulsively interacts with pinned magnetic fields established within the superconducting tapered tube to create a pressure on the tapered tube which produces a propulsive force directed toward the tapered tube's converging end.

This application is a continuation-in-part of the non-provisional patent application Ser. No. 13/373,403, filed Nov. 14, 2011, and claims priority for the matter disclosed therein.

### FIELD OF THE INVENTION

The present invention relates to superconducting magnetic propulsion systems.

The present invention relates to the magnetic field exclusion below a critical temperature in a superconductor, i.e., the Meissner effect.

The present invention relates to high critical temperature type II superconductor

### BACKGROUND OF THE INVENTION

There is a history of magnetic levitation and magnetic propulsion systems, for example:

H. Johnson, 1995. “Magnetic propulsion system”. U.S. Pat. No. 5,402,021 and M. Brady, 2004. “Permanent magnet machine (Perendev)”. WO 2006/045333. The inventions of Johnson and Brady use non-superconductors.

Y. Kambe, 1996. Yoshitaka (JP)—TOYOTA MOTOR CO LTD (JP). EP0748033. The invention of Kambe uses a magnetic field source and superconducting material.

G. Lanzara, 1990. “Magnetically levitated vehicle with superconducting mirror sheets interacting with guideway magnetic fields.” U.S. Pat. No. 4,979,445. The magnetic levitation invention of Lanzara uses a magnetic field source and a superconducting material exhibiting the Meissner effect; however, unlike the present invention, its magnetic field source is not secured to the superconductor.

### SUMMARY OF THE INVENTION

The object of the present invention is to provide an electromagnetically developed propulsive thrust from a hollow, conically-shaped superconductor, i.e., a tapered tube, driven by a magnetic field generated by a superconducting solenoid, or similar magnetic field source. A magnetic field generated by an electrically driven magnetic field source is applied to a preferably high temperature superconductor having the shape of a tapered tube. After the magnetic field is established, the tapered tube superconductor is cryogenically cooled to and below the critical temperature, forcing the magnetic field mostly out of the superconducting tapered tube. Experimental verification is provided below [0033].

The system comprising the superconductor tapered tube and superconducting solenoid may be cooled below its critical temperature by contact with a cryogenic material. For example, the system may be cooled by immersion in a cryogenic fluid coolant like liquid helium or liquid nitrogen, by forced circulation of the coolant through the system, or by being placed in contact with a solid coolant such as cryogenic solid neon. Furthermore, the system may be cooled by means of a mechanical heat engine, such as a Stirling engine, or by a solid state Peltier thermoelectric cooling device.

Superconductors normally function as magnetic field shields, but they lose their shielding properties when the magnetic field becomes very strong. This is especially problematic with type I superconductors. Type II superconductors are able to maintain their superconducting state even when exposed to much higher magnetic field intensities, but, as described above, they do not function as perfect magnetic field shields. When such a superconductor is below its critical temperature T_{c} and subject to critical magnetic field strengths in the range between H_{c1} and H_{c2}, the Meissner effect is less perfect, there being some magnetic field leakage through the type II superconductor. Nevertheless, the proposed invention works adequately to produce propulsion even if the shield is fabricated from a type II superconductor.

The present invention is not predicated on a hydrodynamical interaction between the surrounding fluid and the superconductor solid part. The cryogenic fluid is merely one illustrative example of a cooling medium that is necessary in both embodiments for the superconductor solid part to maintain its superconductive properties and therefore, through the Meissner effect, to repulsively interact with the applied external magnetic field in order to produce a propulsive force. Moreover, it is emphasized that equation (5) presented below that expresses the force being generated in the preferred embodiment of the invention is not an equation of hydrodynamics involving any parameters of a working fluid, but an equation derived from the classical theory of magnetic fields.

One principal feature of the present invention is that the superconductor, which functions as a magnetic field shield, has the form of a tapered tube that surrounds and constrains the lines of magnetic flux produced by the magnetic field source, preventing their outward penetration and causing them to converge within the tapered tube magnetic field shield enclosure and thereby resulting in a pressure against the shield's inner surface. The magnetic field pressure acting on the shield acts as a propulsive thrust in the direction of the shield's narrower end, hence, in the direction of field line convergence.

The ability to magnetically induce a thrust on a superconductor may appear paradoxical, however, this is comparable to the apparent paradoxical effect of the Faraday disc generator where the magnetic field produced by a rotating magnet electrodynamically induces currents in a copper disc cemented to the magnet (One-piece Faraday generator: A paradoxical experiment from 1851. Crooks, et al. July 1978 μm. J. Phys., vol. 46, no. 7, pp. 729-731). In both cases the apparent paradox is resolved if the magnetic field is understood to be deployed in space in a manner independent of its field source. For example, Michael Faraday, the originator of the law of electromagnetic induction (F=qv×B), in 1831 had observed that the magnetic field created by a magnet was not rigidly attached to its source magnet, but that it behaved independently of its magnet. He observed this in experiments he conducted with a copper disc cemented to a rotating cylindrical magnet whose axis of rotation was aligned with its axis of magnetization. In paragraphs 256, 257, and 258 of his diary, dated Dec. 26, 1831, he describes that when he connected a galvanometer between the center and edge of the rotating copper disc, he observed a voltage whose polarity was correlated with the direction of rotation and that was registered even when the magnet instead had remained still while the copper disc rotated (Faraday's Diary, Michael Faraday, Thomas Martin (editor), Royal Institution of Great Britain, 2008, vol. I, pp. 402-403). He comments there: “A rotary and a stationary magnet cause the same effect.” He conversely found that keeping the copper disc stationary while revolving the magnet produced no galvanometer voltage. This leads to the apparent conclusion that the magnetic field of a revolving magnet remains stationary in space. This is also consistent with convention in electromagnetic theory which considers that when an antenna radiates electromagnetic waves, these waves propagate forward with no rigid attachment to the antenna that emitted them, while exerting only a small reaction force on the antenna, the so called radiation reaction.

In a similar fashion, the magnetic field generated by a solenoid may be considered to establish itself in space and to exert a pressure on the adjacent tapered tube superconductor shield while at the same time having no rigid attachment to the solenoid that generates this field. The same principle can explain the levitation of a maglev train by a magnetic field produced by a solenoid situated on the train track and inducing a repulsive magnetic field in an overlying horizontal superconductor situated on the train thereby raising the train above its track. Or alternatively, the same principle can explain the transverse thrust that a solenoid's magnetic field induces on a maglev train that employs tiltable superconductor plates, as described in the patent by Lanzara (U.S. Pat. No. 4,979,445). In the case of the Lanzara maglev apparatus where the superconductor plates are tilted relative to the magnetic field axis, the magnetic lines of flux adjacent to the superconductor shield surface produce a thrust according to the Meissner effect and this thrust has a component oriented either toward the front of the train or toward its rear depending on the tilt of the shield surface. So regardless of whether the magnetic field source is fixed on the ground and develops a motion relative to the repelling superconductor shield, as in the maglev apparatus, or whether the magnetic field source is attached to the superconductor shield, as in the case of the present invention, the repulsion between the magnetic lines of flux adjacent to the shield surface and the pinned magnetic fields created by supercurrents in the superconductor shield occurs in a similar manner in both cases. This thrust effect in both cases is a phenomenon peculiar to the use of superconductors and their ability through the Meissner effect to create magnetic lines of flux opposing the external magnetic field.

The present invention does not claim a mechanism contravening the law of energy conservation. First, to achieve its superconducting state for a given magnetic field intensity H_{c1}, the system must cool below its minimum critical temperature T_{c1}. Maintaining this minimum critical temperature requires a continual expenditure of energy necessitating an energy supply. If forced circulation of a cryogenic liquid is employed, an additional energy supply is necessary to sustain this circulation. Furthermore, an input of energy is necessary when a superconductor solenoid is employed as the means for applying a magnetic field.

Nevertheless, it is reasonable to inquire where the device herein disclosed acquires its energy for propulsion. This question is equivalent to asking where a maglev train superconductor acquires the energy that levitates it above its track. Consider the ideal case of a maglev train which rests on a rail that contains underlying embedded permanent magnets each of whose field axes points upward towards overlying horizontally disposed high-temperature superconductor plates attached to the bottom of the train. Imagine that initially these superconductor plates are above their critical temperature and that the train rests firmly on its rails, the magnetic field from each magnet passing through its overlying superconductor. Now, a cryogenic liquid is added to insulated containers that surround each plate to cool them below their critical temperature. As the plates become superconducting, they develop supercurrents which produce pinned magnetic fields having a polarity opposed to the magnetic fields from the underlying magnets and they repulsively expel those fields. The mutual repulsion of these opposed fields levitates the train, a process that requires energy. The energy required for levitating each plate amounts to the weight resting on that plate, multiplied by the acceleration of gravity, multiplied by the levitated distance which would be approximately 1.5 centimeters.

Related to this, there is the question of how the pinned fields in the superconductor plates sustain themselves to continue this repulsion as they keep the train levitated. What centripetal force acts to keep Cooper pair electrons indefinitely circling as supercurrents and forming their pinned fields when at the same time these fields are being forcefully opposed by the external magnetic field that these fields are actively expelling? These supercurrents cannot be circling due to the effect of the external magnetic field, since the generated pinned fields for the most part expel this external field from the superconductor. Furthermore it is unlikely that these supercurrents or their pinned fields would be drawing the required energy for levitating the train from this external magnetic field because the pinned fields are opposing these magnetic fields. It is also unlikely that in creating their pinned fields that the supercurrents draw energy from the superconductor's environment, that is, from the surrounding cryogen cooling bath. This would go against the conventional understanding that heat flows out of the superconductor into its cooling bath as it cools below its critical temperature, and not vice versa.

One possible alternative is that this energy comes from the quantum field itself. This is a reasonable possibility since the phenomenon of superconductivity is generally considered to be a quantum phenomenon. Quantum field theory, as conventionally taught, holds that the field of any particle, including the Cooper pair electrons in superconductor supercurrents, are nonlocalized, hence that the fields of such Cooper pair electrons as well as the fields of the particles forming the substance of the superconductor are intertwined with the quantum vacuum which extends everywhere through space and which is theorized to comprise a vast store of energy. So, one explanation would be that when supercurrents create and sustain themselves and their pinned magnetic fields which levitate the train, they are drawing energy from this omnipresent reservoir. The same reasoning discussed in regard to the maglev train example also pertains to the present invention which similarly involves a superconductor form generating pinned fields which repel an externally applied magnetic field.

Regardless of the question of where the pinned fields acquire their energy, in the case of the presently disclosed propulsion device, the thrust effect on the superconducting tapered tube may be seen to be predicted by the accepted laws of classical magnetism, as described below [0035-[0039].

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a cross-sectional view of a device capable of developing a propulsive thrust which consists of a superconducting tapered tube with a magnetic field source superconducting solenoid at its narrow end producing a magnetic field that acts on the superconducting tapered tube to create a thrust.

FIG. 2 displays a cross-sectional view of the thrust-producing device that presents a second arrangement between the solenoid and the superconducting tapered tube, different from that shown in FIG. 1.

FIG. 3 presents a cross-sectional view of the upper half of the thrust-producing device shown in FIG. 2 which depicts the arrangement of the magnetic lines of flux around the type II superconducting tapered tube, as based on a computer simulation carried out by the program Quick Field, Finite Element Systems (User's Guide Version 5.3, Terra Analysis Ltd, 2005).

FIG. 4 illustrates how trapped flux in an YBCO superconductor varies with the superconductor's temperature when excited with a magnetic field flux ranging from 6 to 8 Tesla.

FIG. 5 illustrates the propulsion device tested in November 2012.

FIG. 6 illustrates an experiment carried out by A. Nassikas which shows the type II superconducting tapered tube responding to a Meissner-effect-mediated magnetic field as it and its liquid nitrogen bath are both suspended on a Teflon line in a pendulum manner.

### DETAILED DESCRIPTION OF A BEST MODE

The following description is of the best mode presently contemplated for carrying out the invention. This description is not to be taken in a limiting sense, but is merely made for the purpose of describing the general principles of the invention.

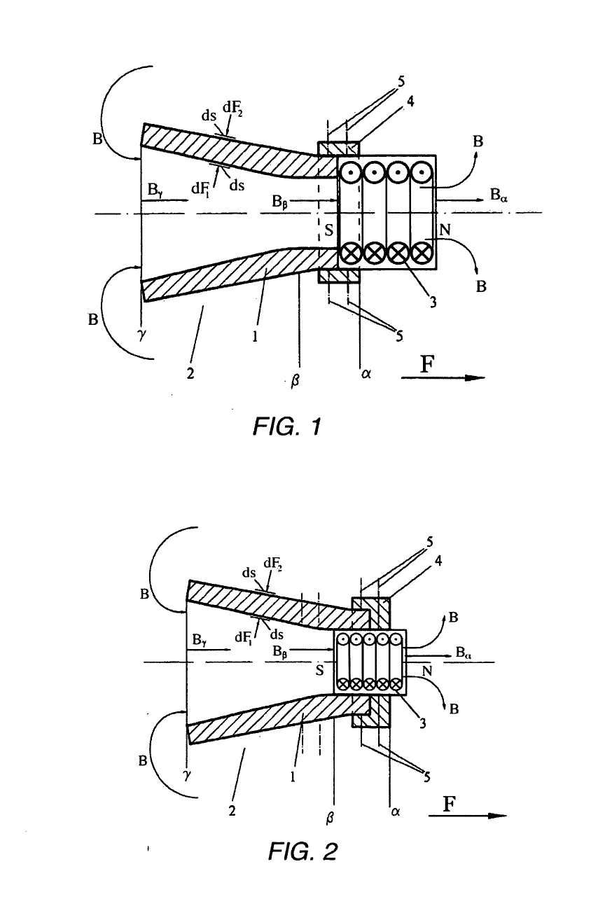

The present invention comprises a magnetic propulsion device (2) consisting of a superconductive tapered tube (1), preferably made from a type II superconductor, and a solenoid (3) fixed to the narrow end of the tapered tube as shown in FIG. 1 and FIG. 2 such that its primary magnetic field axis is approximately coaxial with the tapered tube's axis of symmetry. The tapered tube would have a thickness sufficient to shield most of the external magnetic flux impinging upon it. Solenoid (3) may be either a normal solenoid or a superconductive solenoid. An energy supply is required to maintain the current in the solenoid against resistive losses if it is a normal solenoid, or to energize the superconducting coil in the case where it is a superconducting solenoid. This energy supply is not depicted in FIGS. 1 and 2.

The solenoids employed in these embodiments may be either normal solenoids, solenoids with magnetizable cores, or superconductive solenoids. The solenoids may be wound either as bobbins or as a series of adjacent, coaxial pancake coils. In the third embodiment, the diameter of the pancake coils would progressively decrease to conform to the converging shape of the tapered tube throat. In all embodiments an energy supply is required to maintain the current in the solenoids against resistive losses if it is a normal solenoid, or to provide an energizing power source in the case where the solenoid is a superconducting solenoid. Although an energy supply for the solenoids is not depicted in FIGS. 1 and 2, it should nevertheless be understood that one is present.

Examples of type II superconductors, also referred to as high-temperature superconductors, include cuprate ceramic materials such as Y—Ba—Cu—O (YBCO) or Sm—Ba—Cu—O which more generally are called REBCO (Rare Earth-Ba₂Cu₃O₇₋ₓ) superconductors. The superconductor Sm—Ba—Cu—O is able to trap magnetic fields to produce pinned fields as large as 10 Tesla (Melt-processed Sm—Ba—Cu—O superconductors trapping strong magnetic field H. Ikuta et al. 1998 Supercond. Sci. Technol. 11 1345-1347). Bulk YBCO superconductors have been shown to trap magnetic fields as high as 17 Tesla (High temperature superconductor bulk magnets that can trap magnetic fields of over 17 tesla at 29 K. M. Tomita & M. Murakami 2003 Nature, vol. 421, pp. 517-520). Melt-texturing of a REBCO type II superconductor during its fabrication improves its ability to trap magnetic fields even at liquid nitrogen temperatures (Polycrystalline HTS material for bearings and electric power devices. F. N. Werfel, et al. 2001 Physica C, vol. 357-360, pp. 843-851.) (Superconductor bearings, flywheels and transportation. F. N. Werfel, et al. 2012 Supercond. Sci. Technol., vol. 25, 014007, 16 pp.).

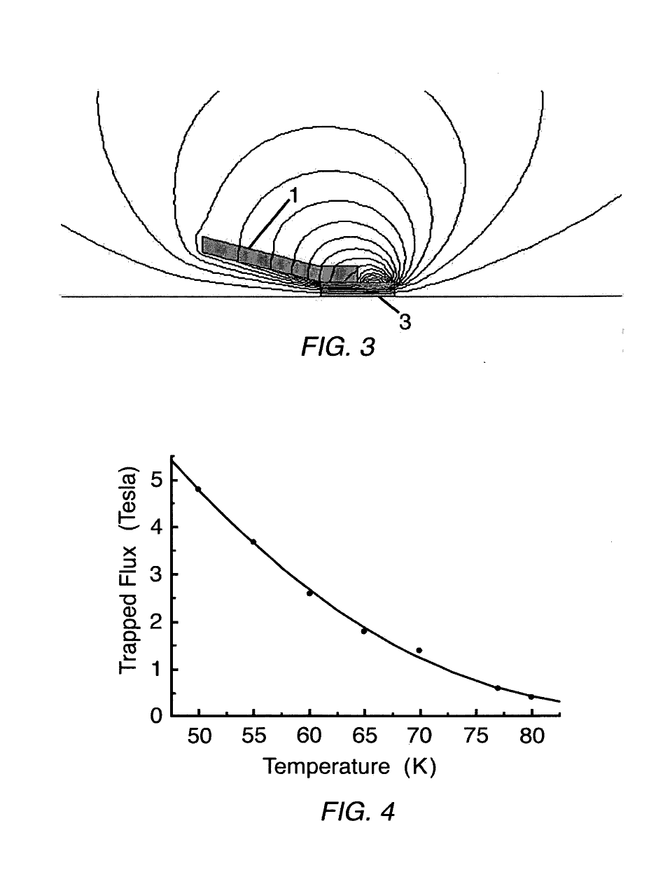

The following presents one way of understanding the field-propulsion effect that is the subject of the present invention. The magnetic field originating from solenoid (3) of the present invention may be considered to establish itself in the space surrounding the solenoid. Furthermore, when this generated field encounters a magnetic barrier comprised of a superconducting tapered tube shield (1) that exhibits the Meissner effect, the vortex current which this external field induces within the tapered tube will generate a pinned field throughout the tapered tube shield that opposes and repels this external field. As a result, the external field will impart a repulsive force to the tapered tube shield. This external generated magnetic field will exert the repulsive force on all sides of the tapered tube shield, but in varying amounts due to the variation in magnetic field intensity present over differing sectors of the shield's surface. As may be seen in FIG. 3, the magnetic field contacting the inner surface of the shield, within the tapered tube's throat, will have a greater strength than that contacting the outer surface of the shield. This is because, within the tapered tube throat, the magnetic lines of force have a close proximity to the magnetic field source and are forced to converge to a high intensity by the confinement within the tapered tube throat, whereas in the vicinity of the more distal outer surface of the shield the magnetic lines of force are deployed through a much larger volume of space as they are between the solenoid's two poles and hence the outer surface of the superconducting tapered tube shield is exposed to a much weaker field intensity. As a result of this difference in field intensity, unbalanced forces will develop on the superconducting shield. That is, the incremental magnetic force dF₁ pushing outward against an incremental surface ds of the inner surface of the shield produces an incremental magnetic pressure (dF₁/ds) which is greater than the incremental magnetic pressure (dF₂/ds) pushing inward against the outer surface of the tapered tube shield (FIG. 1, FIG. 2); i.e., dF₁>>dF₂. The resultant force (or pressure) vector components oriented perpendicular to the tapered tube's axis of symmetry will cancel out one another. But the force (or pressure) vector resultant directed parallel to the tapered tube's axis of symmetry will be aimed in the direction of tapered tube convergence and will act to propel the tapered tube in this convergence direction. This result is obtained regardless of the cross-sectional geometry of the tapered tube, i.e., regardless as to whether the tapered tube has a circular, elliptical, rectangular, or polygonal cross section.

### Experiment

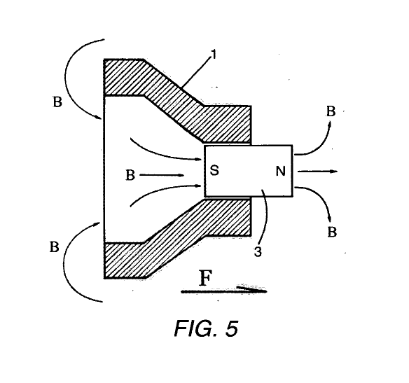

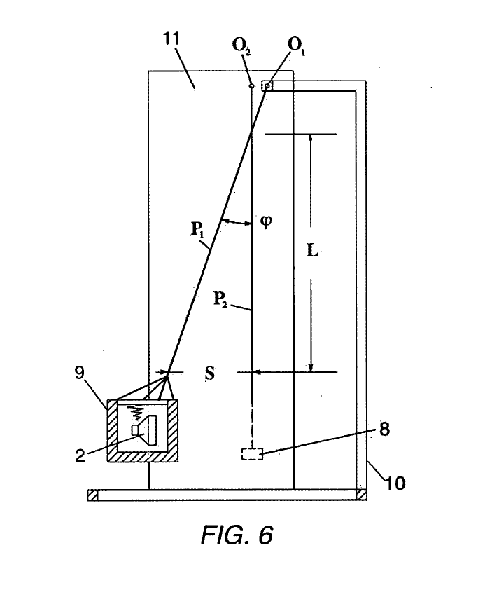

An experiment was performed by A. Nassikas in November 2012 in a closed laboratory room free of air currents. A tapered tube was constructed which had a form similar to that shown in FIG. 5. The tapered tube (1) was made of the type II superconductor YBCO (Yttrium-Barium-Copper-Oxide) and designed with a wall thickness of 7 mm and a taper of 45° connecting its wide end (3.5 cm ID) to its narrow end (1.29 cm ID). A magnetic field source (3) was fixed within the tapered tube's narrow end to produce an axial magnetic field that was coaxially aligned with the tapered tube's axis of symmetry. The propulsion device (2), consisting of the tapered tube and its attached magnetic field source, was placed within an insulated container (9) filled with liquid nitrogen and both were together suspended at the end of a Teflon thread P₁ which was secured to a fixed point O₁ on a rigid support (10) to form a pendulum; see FIG. 6. A second nonmagnetic pendulum bob (8) was hung from point O₂ by thread P₂ so as to serve as a reference plum adjacent to the main pendulum. A black backdrop (11) was placed behind the pendulum bobs to increase the visibility of their threads. When the YBCO tapered tube became superconducting, the device was seen to move from its plumb position. Thread P₁ was witnessed to become displaced laterally from P₂ by S=0.7 cm for a vertical thread segment length measuring L=80 cm. That is, P₁ made an angle of 0.5 degrees relative to P₂. The tank together with the propulsion device weighed w=250 grams. So, the superconducting tapered tube device and its tank were being displaced horizontally by a force of F=w×S/L=2.2 grams. Thus the test was witnessed to have a positive result. The magnetic field source (3) of the propulsion device is estimated to have produced a trapped flux of approximately 0.04 Tesla in the superconducting tapered tube.

### Numerical Calculation

In general, the inner-directed forces (dF₂) acting on the outer surface of the tapered tube will be far weaker than the outer-directed forces (dF₁) acting on the inner surface of the tapered tube, hence acting within the throat of the tapered tube. So to a first approximation, the forces acting on the outer surface of the tapered tube may be neglected and we may calculate the propulsion force acting on the tapered tube solely in terms of the forces acting on the tube within its throat.

To make such a calculation we begin on the basis of the classical theory of the magnetic field. The equation for the force exerted on a closed surface S is given as:

$$F = \frac{1}{2} {∯}_{S} [ H ( n \cdot B ) + B ( n \cdot H ) - n ( H \cdot B ) ] d S \qquad ( 1 )$$

where H is the magnetic field intensity, B is the flux density, and n is the unit vector perpendicular to surface S under consideration, which faces outwardly from this surface.

In expressing the force exerted on a superconducting magnetic field shield, we take n·B=0 and n·H=0 which sets the first two terms in equation (1) to zero, giving:

$$F = - \frac{1}{2} {∯}_{S} n ( H \cdot B ) d S \qquad ( 2 )$$

This means that the force exerted on a surface element dS will equal:

dF=−½n(H·B)dS (3)

Consequently, a magnetic field with properties H and B existing in the vicinity of a magnetic field shield element dS, with μₒ the magnetic permeability and n=1, will create a pressure p on this element, such that:

$$p = d F / d S = \frac{1}{2} ( H \cdot B ) = \frac{1}{2 {μ}_{0}} {B}^{2} \qquad ( 4 )$$

This indicates that by means of a solenoid and a magnetic field shield, configured in the above stated manner, that it is possible to create a variety of magnetic propulsion engines, the propulsive force of which is given by pressure equation (4).

It is important to note that the London equations are accepted as being valid in the description of phenomena taking place within the superconducting material where the pinning forces and trapped fields related to the present invention are being created, while far from this region Maxwell's equations dominate as the valid descriptor. However we do know that Eq. (1) of classical magnetism can be applied to the present invention because the surface S for integrating Eq. (1) may be chosen to lie outside of any material component, hence far from the superconductor domain. So Eq. (1) provides an adequate theoretical basis for understanding the operation of the present invention. More specifically, in the present invention, Eq. (1) applies precisely for boundary conditions with μ=0, corresponding to type I superconductors, hence to materials that are known to exist and can be approximately extended to type II superconductors, which have μ very small or a μ that is anisotropic.

On the basis of the classical theory of magnetism, the magnetic force exerted on a closed surface S is given by Eq. (1). Applying Eq. (1) for the calculation of the force on the tapered tube under discussion we have:

$$F ≅ \frac{{n}_{α}}{2 {π}_{0}} ( {A}_{α} {B}_{α}^{2} - {A}_{γ} {B}_{γ}^{2} ) = \frac{Φ {n}_{α}}{2 {μ}_{0}} ( {B}_{α} - {B}_{γ} ) \qquad ( 5 )$$

where, B_{α} and B_{γ} are the magnetic field intensities at respectively the smaller and the larger sections shown in FIG. 1 or FIG. 2, where Φ=A_{α}×B_{α}=A_{γ}×B_{γ} is the magnetic flux, and A_{α} and A_{γ} are the cross sectional areas of those respective sections. This equation indicates that the thrust is towards the direction of convergence, that is towards the smaller section α.

The above equation represents the interaction between the magnetic field (B) and the superconducting shield (1). In reality near the magnetic field shield, the situation is more complicated, involving quantum phenomena related to Cooper pair flux trapping. It is important to note that Eq. (5) above indicates that the propulsive force developed on the shield scale's approximately according to B², the square of the magnetic flux density of the solenoid (3), and according to the difference in cross-sectional area A. The approximation symbol “≈” is used for two reasons. First, this equation assumes that the vector B is perpendicular and constant at all points of the cross sectional areas A_{α} and A_{γ}, which is only approximately valid. Second, Eq. (5), in its accurate form, is valid only for the case where material (1) is a type I superconductor, which is of a type that does not permit the passage of any magnetic field. Thus, by designating its approximate version, the formula, Eq. (5), pertains also to type II superconductors which have some magnetic field leakage.

A numerical calculation of the propulsion force F may be made with the aid of the Quick Field Finite Element Systems program [Quick Field, Finite Element Systems, User's Guide Version 5.3—Terra Analysis Ltd. (2005)]. This program is used for calculating magnetostatic forces wherever they appear in electromagnetic machines. Such a program, for example, has been used to calculate the net force created by the field depicted in FIG. 3 which is related to the present invention. This calculation is precise for superconductors that have boundary conditions with μ=0 (type I superconductors), and can be approximately extended to type II superconductors, which have μ very small. Such calculations give a better approximation when they take into account the anisotropic behavior of μ in type II superconductors.

Temperatures in the range of 40 to 50 K have been obtained in outer space on spacecraft in Earth orbit that have been shaded by a sunshield, as in the case of the James Webb Space Telescope. Consequently, in application to the propulsion of a satellite or spacecraft in outer space, the present invention may not require cooling to maintain the superconductive state of its tapered tube if the tube is fabricated from a type II superconductor.

In the above disclosed magnetic propulsion device, it is useful to be able to control the magnitude of the propulsion force or even turn it off. One way of doing this is by controlling the magnitude of the magnetic flux produced by the solenoid (3) or by changing its position relative to the tapered tube throat. Another way of doing this is to change the temperature of the superconductor shield which in turn changes the magnitude of the trapped magnetic flux. As seen in FIG. 6, the magnitude of the magnetic flux trapped in a type II superconductor varies with the superconductor's temperature, increasing as the superconductor's temperature progressively drops below its critical temperature. As a result, at progressively lower temperatures, an external magnetic field will exert a progressively greater force on the superconductor shield. On the other hand, if the superconductor's temperature is allowed to rise above its critical point, its trapped flux will approach zero and the propulsive force on the shield will shut off. Once cooling is restored to its shield, the propulsive device will again generate a propulsion force. One way of regulating the temperature of the superconductor shield is by changing the speed of the heat pump cooler used to refrigerate the shield or, if a thermoelectric cooler is used, by changing the voltage on the Peltier cooler. Alternatively, by turning the cooler off entirely to allow the superconductor to heat up above its critical point, the propulsive force will shut off. Alternatively, the temperature of the superconductor shield may be raised or lowered by making or breaking the thermal contact path between the shield and its cooler, for example by means of an actuator relay. In outer space where the temperature is sufficiently low for superconductivity the temperature of the superconductive tapered tube may be controlled by means of an electrical heater.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention.

What is claimed is:

1.-3. (canceled)

4. An apparatus for developing a propulsive force, comprising:
a superconductor magnetic field shield means configured in the form of a tapered tube;
means for generating a magnetic field where said means is fixedly attached partially within said shield means at the narrow end of said field shield means; and
means for cooling said superconductor magnetic field shield means to maintain superconductive conditions;
the magnetic flux of said magnetic field generating means producing a net propulsive force on said superconductor magnetic field shield means wherein the entirety of said magnetic field shield means and said magnetic field generating means are propelled.

5. An apparatus for developing a propulsive force as claimed in claim 4 wherein the means for generating a magnetic field is a solenoid, said solenoid either having a magnetizable core or being a superconductive solenoid.

6. An apparatus for developing a propulsive force as claimed in claim 5 comprising: control means wherein the field intensity of the solenoid is varied by changing its current.

7. An apparatus for developing a propulsive force as claimed in claim 4 wherein the means for cooling said superconductor magnetic field shield means is a cryogenic material.

8. An apparatus for developing a propulsive force as claimed in claim 4 wherein means for cooling said superconductor magnetic field shield means is a heat engine.

9. An apparatus for developing a propulsive force as claimed in claim 4 wherein means for cooling said superconductor magnetic field shield means is a thermoelectric cooler.

10. An apparatus for developing a propulsive force as claimed in claim 4, comprising: control means for varying the temperature of said superconducting shield in a controlled manner to change the superconductive state of said magnetic field shield.

11. An apparatus for developing a propulsive force as claimed in claim 4 wherein said means for cooling said magnetic field shield means is a sunshade.

12. An apparatus for developing a propulsive force as claimed in claim 4 wherein means for controlling the temperature of said superconductor magnetic field shield means is an electric heater.

13. An apparatus for developing a propulsive force, comprising:
a tapered tube composed of a type II superconductor; and
a solenoid for creating a magnetic field wherein the solenoid is fixed partially within the narrow end of said tapered tube and wherein a primary magnetic field axis of said solenoid is coaxial with the axis of symmetry of said tapered tube.
